(19) United States
(12) Patent Application Publication
(10) Pub. No.: US 2026/0031884 A1
(43) Pub. Date: Jan. 29, 2026

(54) BEAM REPORTING ENHANCEMENT METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/998,021

(22) PCT Filed: Aug. 2, 2022
(86) PCT No.: PCT/CN2022/109807

§ 371 Date: Jan. 23, 2025

(51) Int. Cl. H04B 7/06; H04W 24/10

(52) U.S. Cl. CPC H04B 7/06952; H04B 7/0626; H04W 24/10

(57) ABSTRACT

A method for beam reporting enhancement, performed by user equipment (UE), and includes: sending reporting information, where the reporting information includes identification information used, in a case where the UE supports simultaneous transmission via multi-panel (STxMP), for distinguishing a plurality of beams.

### CROSS-REFERENCE

The present application is a U.S. National Stage of International Application No. PCT/CN2022/109807, filed on Aug. 2, 2022, the contents of all of which are incorporated herein by reference in their entireties for all purposes.

### BACKGROUND OF THE INVENTION

In the related art, e.g., in a multiple-in multiple-out (MIMO) enhancement technology of R18, it is considered to realize simultaneous uplink transmission towards a plurality of transmission reception points (TRPs) via a plurality of panels. This simultaneous uplink transmission may be used for further improving the system transmission throughput and transmission reliability, etc., of uplink. In order to support simultaneous transmission via multi-panel (STxMP) in R18, a plurality of uplink beams from different antenna panels suitable for uplink simultaneous transmission need to be determined for UE.

### SUMMARY OF THE INVENTION

Examples of the disclosure provide a method and apparatus for beam reporting enhancement, and a communication device and a storage medium.

According to a first aspect of the disclosure, a method for beam reporting enhancement is provided and performed by UE, and includes:
sending reporting information, where the reporting information includes identification information used, in a case where the UE supports STxMP, for distinguishing a plurality of beams.

According to a second aspect of the disclosure, a method for beam reporting enhancement is provided and performed by a network device, and includes:
receiving reporting information, where the reporting information includes identification information used, in a case where UE supports STxMP, for distinguishing a plurality of beams.

According to a third aspect of the disclosure, a communication device is provided, including:
one or more processors; and a memory configured to store executable instructions for the one or more processors. Where the one or more processors are configured to perform the following steps when executing the executable instructions:
sending reporting information, wherein the reporting information comprises identification information used, in a case where the UE supports simultaneous transmission via multi-panel (STxMP), for distinguishing a plurality of beams.

According to a fourth aspect of the disclosure, a non-transitory computer storage medium is provided, storing a computer executable program, where the executable program, when executed by one or more processors, implements a method for beam reporting enhancement provided by the first aspect above.

It is to be understood that the above general descriptions and later detailed descriptions are merely examples and illustrative, and cannot limit the examples of the disclosure.

### BRIEF DESCRIPTION OF DRAWINGS

FIG. 1 is a schematic structural diagram of a wireless communication system illustrated according to an example.

FIG. 2 is a schematic diagram of MP-MTRP transmission under an S-DCI schedule illustrated according to an example.

FIG. 3 is a schematic diagram of MP-MTRP transmission under an M-DCI schedule illustrated according to an example.

FIG. 4 is a schematic diagram of a method for beam reporting enhancement illustrated according to an example.

FIG. 5 is a schematic diagram of a method for beam reporting enhancement illustrated according to an example.

FIG. 6 is a schematic diagram of a method for beam reporting enhancement illustrated according to an example.

FIG. 7 is a schematic diagram of a method for beam reporting enhancement illustrated according to an example.

FIG. 8 is a block diagram of an apparatus for beam reporting enhancement illustrated according to an example.

FIG. 9 is a block diagram of an apparatus for beam reporting enhancement illustrated according to an example.

FIG. 10 is a block diagram of UE illustrated according to an example.

FIG. 11 is a block diagram of a base station illustrated according to an example.

### DETAILED DESCRIPTION OF THE INVENTION

Examples will be illustrated in detail here, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the examples of the disclosure. Rather, they are merely instances of apparatuses and methods consistent with some aspects of the examples of the disclosure as detailed in the appended claims.

Terms used in the examples of the disclosure are merely for the purpose of describing specific examples, and are not intended to limit the examples of the disclosure. Singular forms “one” and “the” used in the examples of the disclosure and the appended claims are also intended to include plural forms unless the context clearly indicates other meanings. It is also to be understood that a term “and/or” as used here refers to and contains any or all possible combinations of one or more associated listed items.

It is to be understood that although terms first, second, third, etc. may be used for describing various information in the examples of the disclosure, such information is not to be limited to these terms. These terms are merely used for distinguishing the same type of information from each other. For example, without departing from the scope of the examples of the disclosure, first information may also be referred to as second information, and similarly, the second information may also be referred to as the first information. Depending on the context, for example, a word “if” as used here may be interpreted as “at the time” or “when” or “in response to determining”.

The disclosure relates to, but is not limited to, the technical field of communications, in particular to a method and apparatus for beam reporting enhancement, and a communication device and a storage medium.

In R17, a beam reporting process is enhanced. A UE capability value set index of a beam is reported while beam information is reported, so as to be used for supporting a function of notifying user equipment (UE) of a panel selected for uplink transmission by updating a transmission configuration indication state (TCI state). The current selection of antenna panels and beam reporting are only applicable to a case where UE capability value set indexes corresponding to antenna panels are different; and for antenna panels with the same UE capability value set indexes, selection and distinguishing are not possible, so that STxMP cannot be well supported.

Referring to FIG. 1, it shows a schematic structural diagram of a wireless communication system provided by an example of the disclosure. As shown in FIG. 1, the wireless communication system is a communication system based on a cellular mobile communication technology. The wireless communication system may include: a plurality of pieces of user equipment 110 and a plurality of base stations 120.

The user equipment 110 may refer to devices that provide a user with speech and/or data connectivity. The user equipment 110 may communicate with one or more core networks via a radio access network (RAN), and the user equipment 110 may be Internet of Things user equipment, such as a sensor device, a mobile phone (or “cellular” phone), and a computer with Internet of Things user equipment, which may be, for example, fixed, portable, pocket-sized, handheld, computer-built, or vehicle-mounted apparatuses, for example, a station (STA), a subscriber unit, a subscriber station, a mobile station, a mobile, a remote station, an access point, a remote terminal, an access terminal, a user terminal, a user agent, a user device, or user equipment. Or, the user equipment 110 may also be unmanned aircraft devices. Or, the user equipment 110 may also be vehicle-mounted devices, such as a trip computer with a wireless communication function, or wireless communication equipment connected with an external trip computer. Or, the user equipment 110 may also be roadside devices, such as a street lamp, a signal light or other roadside devices with wireless communication functions.

The base stations 120 may be network side devices in the wireless communication system. The wireless communication system may be the 4th generation mobile communication (4G) system, also known as a long term evolution (LTE) system; or, the wireless communication system may be a 5G system, also known as a new radio system or 5G NR system. Or, the wireless communication system may also be a next-generation system of the 5G system. An access network in the 5G system may be called a new generation-radio access network (NG-RAN).

The base stations 120 may be evolved base stations (eNB) adopted in the 4G system. Or, the base stations 120 may also be base stations adopting centralized and distributed architectures (gNB) in the 5G system. When the base stations 120 adopt the centralized and distributed architectures, they typically each include a central unit (CU) and at least two distributed units (DUs). Protocol stacks of a packet data convergence protocol (PDCP) layer, a radio link control (RLC) layer, and a media access control (MAC) layer are arranged in the central unit. A physical (PHY) layer protocol stack is arranged in the distributed unit. The examples of the disclosure do not limit specific implementation of the base stations 120.

Wireless connections may be established between the base stations 120 and the user equipment 110 through wireless radio. In different implementations, the wireless radio is wireless radio based on the 4th generation mobile communication (4G) standard; or, the wireless radio is wireless radio based on the 5th generation mobile communication (5G) standard, such as new radio; or, the wireless radio may also be wireless radio based on the next-generation mobile communication standard of 5G.

In some examples, end to end (E2E) connections may also be established between the user equipment 110, for example, a vehicle to vehicle (V2V) communication, a vehicle to infrastructure (V2I) communication, a vehicle to pedestrian (V2P) communication and other scenarios in vehicle to everything (V2X) communications.

Here, the user equipment may be considered to be a terminal device of the following example.

In some examples, the wireless communication system of FIG. 1 may further include a network management device 130, as shown.

The plurality of base stations 120 are connected with the network management device 130 respectively. The network management device 130 may be a core network device in the wireless communication system, for example, the network management device 130 may be a mobility management entity (MME) in an evolved packet core (EPC). Or, the network management device may also be other core network devices, such as a serving gateway (SGW), a public data network gateway (PGW), a policy and charging rules function (PCRF) or a home subscriber server (HSS). An implementation form of the network management device 130 is not limited in the examples of the disclosure.

In order to facilitate understanding by those skilled in the art, the examples of the disclosure set forth a plurality of implementations to clearly illustrate the technical solutions of the examples of the disclosure. Certainly, it may be understood by those skilled in the art that the plurality of examples provided in the disclosure may be executed individually, or together with methods of the other examples in the examples of the disclosure when combined, or together with some methods in other related arts after executed individually or in combination, which is not limited by the examples in the disclosure.

In order to better understand the technical solution described in any one of the examples of the disclosure, first, the related art is partially described.

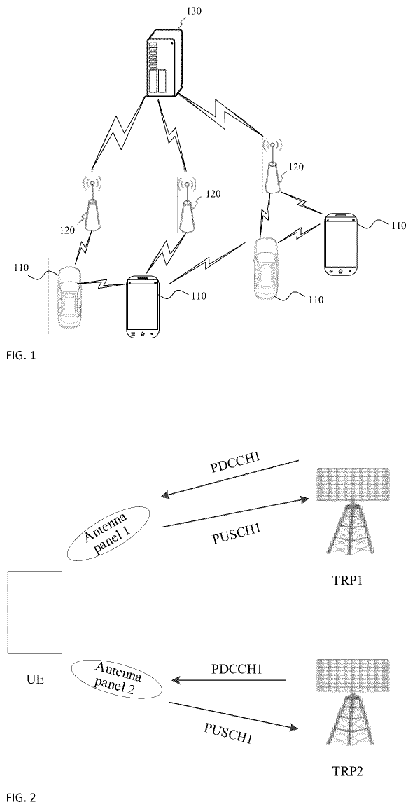

In some application scenarios, in an enhancement target of R18, the reliability and throughput of transmission can be improved by realizing simultaneous collaborative transmission by a plurality of terminal panels to a TRP direction of a plurality of base stations, and at the same time, a transmission delay under a plurality of TRPs may be effectively reduced. However, the UE needs to have a capability of transmitting a plurality of beams simultaneously. As shown in FIG. 2, physical uplink shared channel (PUSCH) transmission may be based on multi-antenna-panel or multi-TRP transmission scheduled by a single physical downlink control channel (PDCCH), i.e., a single piece of DCI (S-DCI). As shown in FIG. 3, multi-antenna-panel or multi-TRP transmission may also be scheduled by different PDCCHs i.e., a plurality of pieces of DCI (M-DCI).

In some application scenarios, a measurement and reporting for beam management may be configured via CSI reporting in the beam management so as to inform a network device of beam information that is currently suitable for transmission. When a report quantity in a report setting is configured as a channel state information resource indicator (CRI) or reference signal receiving power (RSRP) or configured as a synchronization signal block resource indicator (SSBRI) or an RSRB, it indicates beam reporting in the beam management. At this point associated resource settings include a plurality of CSI-RS resources or a plurality of SSBs, and an optimal CRI or SSBRI is determined by the UE according to measurements of RSRP of all the resources. In an example, beam reporting may include: a group-based beam reporting mode and a non-group based channel state information (CSI) measurement reporting mode for beam management.

In an example, for a group-based channel state information (CSI) measurement reporting mode configured for beam management, merely a downlink sending beam indicator obtained from a measurement needs to be reported by the UE. For example, a communication protocol specifies that at a reporting moment, the UE may be configured to report N different base station sending beams simultaneously, and the UE may receive the N different sending beams simultaneously. Here, N may be an integer greater than 0. For example, a maximum configuration of N in a current protocol is 2.

In another example, for the non-group based beam reporting mode, at a reporting moment, the UE may be configured for N different downlink sending beams. Here, N may be an integer greater than 0. For example, a maximum configuration of N in a current protocol is 4.

In some application scenarios, when a base station receives CRI/SSBRI+L1-RSRP/L1-SINR reported by the UE corresponding to a certain UE capability value set index, the base station updates a quasi co-located TypeD (QCL TypeD) resource in an uplink transmission configuration indication state (UL TCI state) using a CSI-RS or SSB recommended by the UE. Here the UE receives a notification of the base station and follows the indication of the base station to use a PUSCH or a physical uplink control channel (PUCCH) sent by the same antenna panel as the one receiving the QCL TypeD resource. Here, a UE capability value set index may include a maximum number of sounding reference signal (SRS) ports supported by each antenna panel, and each pair of CRI/SSBRI+L1-RSRP/L1-SINR in beam reporting corresponds to one UE capability value set index.

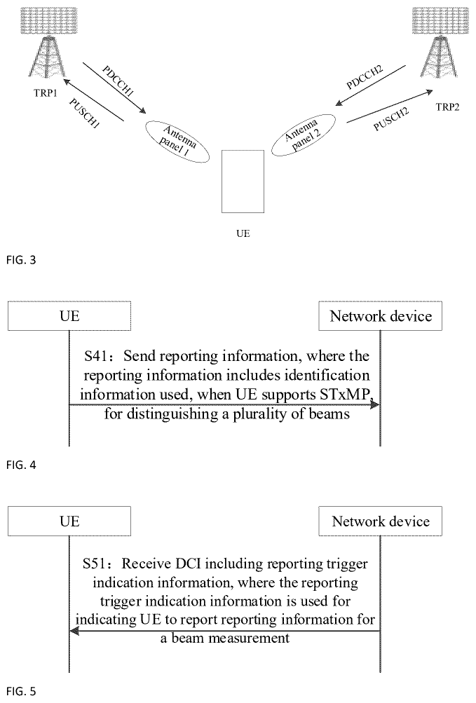

As shown in FIG. 4, an example of the disclosure provides a method for beam reporting enhancement, performed by UE, including step S41.
Step S41: reporting information is sent, where the reporting information includes identification information used, when the UE supports STxMP, for distinguishing a plurality of beams.

In an example, the UE may be various mobile terminals or fixed terminals. For example, the UE may be, but is not limited to, a cellphone, a computer, a server, a wearable device, a game control platform or a multimedia device, and the like.

In an example, the reporting information is used for determining whether the plurality of reported beams are a plurality of beams that support the STxMP. Here, if the identification information of the plurality of beams is different, the plurality of beams are the plurality of beams that support the STxMP; or, if the identification information of the plurality of beams is the same, the plurality of beams are a plurality of beams that do not support the STxMP.

In the example of the disclosure, the identification information of the plurality of reported beams may include identification information of beams of different antenna panels.

In other examples, the identification information of the plurality of reported beams may further include identification information of beams from the same antenna panel. This may enable the base station to determine that the plurality of beams may be a plurality of beams that support non-STxMP.

Here, antenna panel information indexes that are simultaneously reported in step S41 are merely for reported beams with the same UE capability value set indexes obtained from this CSI measurement.

In some examples of the disclosure, a plurality means two or more.

In an example, sending the reporting information in step S41 may be: reporting the reporting information.

In an example, sending the reporting information in step S41 may be: sending the reporting information to the network device.

In an example, the network device may be, but is not limited to, an access network device or a core network device. The access network device may be various types of base stations. For example, it may be a 2G base station, a 3G base station, a 4G base station, a 5G base station, or other evolved base stations. The core network device may be, but is not limited to, various entities or network element functions of a core network. If the network device is a core network device, the reporting information being sent to the core network device by the UE may be as follows: the reporting information is sent to the base station by the UE, and the reporting information is forwarded to the core network device by the base station.

Here, the downlink beam may be a downlink sending beam. In the example of the disclosure, the UE reports the downlink sending beam of the base station. This downlink sending beam is received by a UE downlink receiving beam. At the same time, because beam consistency exists, the downlink sending beam may be used for indicating a corresponding uplink sending beam in the presence of an uplink sending beam. In this way, based on identification information of this downlink sending beam, it may be fed back to the base station for use by a base station scheduler to determine whether a plurality of uplink sending beams corresponding to the plurality of reported downlink sending beams are a plurality of uplink sending beams that support the STxMP.

In this way, in the example of the disclosure, the reporting information is sent to the network device by the UE, where the reporting information includes the identification information used, when the UE supports the STxMP, for distinguishing the plurality of beams. Thus, the network device may be enabled to accurately know whether the plurality of reported beams are from different antenna panels, and thus also accurately know whether the uplink beams corresponding to the plurality of beams are uplink beams that support the STxMP; and then, supporting of the STxMP may be facilitated.

In an example, the identification information at least includes corresponding different antenna panel information indexes in a case where UE capability value set indexes of the plurality of beams are the same.

Here, if the plurality of beams correspond to different reported UE capability value set indexes, the plurality of beams are a plurality of beams from different antenna panels, and the uplink beams corresponding to the plurality of beams are determined to be a plurality of uplink beams that support STxMP; or, UE capability set index values of the plurality of beams are the same but antenna panel information indexes of the plurality of beams are different, the plurality of beams are a plurality of beams from different antenna panels, and uplink beams corresponding to the plurality of beams are determined to be a plurality of uplink beams that support STxMP.

In an example, the identification information of the plurality of beams is different. Here, when the UE capability value set indexes of the plurality of beams are the same, the plurality of different beams may correspond to different antenna panels, and the UE will re-perform mapping between antenna panel information indexes and corresponding panels in accordance with the number of beams that need to be distinguished corresponding to the same UE capability value set indexes. This correspondence is determined by the UE and does not need to be reported to a network, and the network may judge whether different beams correspond to the same panel based on the corresponding UE capability value set indexes and different antenna panel information indexes. Thus, when the beams are reported, the UE capability value set indexes of the beams and the antenna panel information indexes may be reported to determine the identification information of the beams. For example, the identification information of the beams may be a combination of the UE capability value set indexes and the antenna panel information indexes.

For example, the UE determines to report N beams. M beams of the N beams have the same UE capability value set indexes, where N and M are both integers greater than 0, and M is less than or equal to N. For example, the UE capability value set indexes of the M beams are all “UE capability value set index #1”. The UE enhances the indication of the M beams, the antenna panel information index of each beam is added after the UE capability value set index to distinguish different beams. For example, if M is 4, the antenna panel information indexes of the four beams may be “panel #1”, “panel #2”, “panel #3” and “panel #4” respectively. Based on the combinations of the UE capability value set indexes and the antenna panel information indexes of the four beams, the UE determines the identification information of the four beams, and reporting of the antenna panel information indexes is added to the corresponding beams with the same UE capability value set indexes, which may be expressed as “UE capability value set index #1, panel #1”, “UE capability value set index #1, panel #2”, “UE capability value set index #1, panel #3”, and “UE capability value set index #1, panel #4”. Here, the UE capability value set index is defined in accordance with a maximum number of SRS ports supported by panels. For example, the UE has two panels, the two panels may be “panel #0” and “panel #1” respectively, maximum numbers of SRS ports supported by the two panels are 4 and 2 respectively, and then UE capability value set indexes of the two panels may be defined as {4, 2}. Then the UE capability value set index of the panel corresponding to “panel #0” may be “UE capability value set index #0”, and the UE capability value set index of the panel corresponding to “panel #1” may be “UE capability value set index #1”.

In some examples, the antenna panel information index may also be any other numbered index. For example, it may be at least one of indexes “1”, “2”, “#1”, “#2”, “X”, “Y”, and “Z”, and the like. For example, the UE capability value set indexes of the four beams may all be “UE capability value set index #1”, and the antenna panel information indexes of these four beams may be “#1”, “#2”, “#3”, and “#4” respectively. Then the identification information of the four beams may be “UE capability value set index #1, #1”, “UE capability value set index #1, #2”, “UE capability value set index #1, #3”, and “UE capability value set index #1, #4” respectively.

In this way, in the example of the disclosure, the reporting information is sent to the network device by the UE, where the reporting information includes the identification information of the plurality of beams when the UE supports the STxMP. The identification information at least includes corresponding different antenna panel information indexes in a case where UE value set indexes of the plurality of beams are the same. Thus, the network device may be enabled to accurately know whether the plurality of reported beams are from different antenna panels, and thus also accurately know whether the uplink beams corresponding to the plurality of beams are uplink beams that support the STxMP; and then, supporting of the STxMP may be facilitated.

In an example, the identification information includes different UE capability value set indexes of the plurality of beams.

An example of the disclosure provides a method for beam reporting enhancement, performed by UE, including: sending reporting information, where the reporting information includes identification information of a plurality of beams when the UE supports STxMP. The identification information at least includes different UE capability value set indexes of the plurality of beams.

In the example of the disclosure, the identification information is the UE capability value set indexes. There is no need to introduce antenna panel information indexes of the beams to distinguish the different beams.

For example, the UE determines to report N beams. L beams of the N beams have the different UE capability value set indexes, where L and M are both integers greater than 0, and L is less than or equal to M. The UE determines to report the L different UE capability value set indexes. For example, L is 3, and UE capability value set indexes of the three beams are “capability value set index #2”, “capability value set index #3” and “capability value set index #4” respectively; then the UE reports identification information of the three beams, i.e., the UE capability value set indexes “capability value set index #2”, “capability value set index #3” and “capability value set index #4” of the three beams.

In this way, in the example of the disclosure, when the UE capability value set indexes of the plurality of beams are different, it is also possible to merely report the different UE capability value set indexes of the plurality of beams; so that, on the one hand, the network device, such as a base station, can also accurately determine whether the plurality of reported beams are the plurality of beams that support STxMP, on the other hand, the number of bits occupied by the reporting information can be reduced, and thus the signaling overhead is reduced.

An example of the disclosure provides a method for beam reporting enhancement, performed by UE, including: sending reporting information, where the reporting information includes identification information of a plurality of beams when the UE supports STxMP. The identification information at least includes corresponding different antenna panel information indexes in a case where UE capability value set indexes of the plurality of beams are the same, and the identification information further includes different UE capability value set indexes of the plurality of beams.

For example, the UE determines to report N beams. M beams of the N beams have the same UE capability value set indexes, L beams of the N beams have the same UE capability values, where N, M and Lare all integers greater than 0, and M and L are both less than N. The UE reports combinations of the same UE capability value set indexes and antenna panel information indexes when the UE capability value set indexes of the M beams are the same, and reports different UE capability value set indexes of the L beams. For example, M is 4, the UE capability value set indexes of the four beams are all “capability value set index #1”, and the antenna panel information indexes of the four beams are “panel #1”, “panel #2”, “panel #3” and “panel #4” respectively; L is 3, UE capability value set indexes of the three beams are “capability value set index #2”, “capability value set index #3” and “capability value set index #4” respectively; and the identification information of the M and L beams reported by the UE may be “UE capability value set index #1, panel #1”, “UE capability value set index #1, panel #2”, “UE capability value set index #1, panel #3” and “UE capability value set index #1, panel #4”, as well as “capability value set index #2”, “capability value set index #3” and “capability value set index #4” respectively.

In the example of the disclosure, when the UE capability value set indexes of at least some of the plurality of beams are the same, identification information determined based on the UE capability value set indexes of the beams and the antenna panel information indexes may be reported; and/or, when the UE capability values of at least some of the plurality of beams have different values, different UE capability value set indexes in these beams may be reported as identification information. In this way, it is possible to enable a network device, such as a base station, to accurately determine whether the plurality of reported beams are a plurality of beams that support STxMP.

It needs to be noted that, it may be understood by those skilled in the art that the method provided by the example of the disclosure may be executed individually, or together with some methods in the examples of the disclosure or some methods in the related art.

An example of the disclosure provides a method for beam reporting enhancement, performed by UE, including: receiving reporting trigger indication information, where the reporting trigger indication information is used for indicating the UE to report reporting information.

Here, the reporting trigger indication information is used for indicating the UE to report the reporting information for a beam measurement.

Here, receiving the reporting trigger indication information may be: the reporting trigger indication information sent by a network device is received.

As shown in FIG. 5, an example of the disclosure provides a method for beam reporting enhancement, performed by UE, including step S51.
Step S51: DCI including reporting trigger indication information is received, where the reporting trigger indication information is used for indicating the UE to report reporting information for a beam measurement.

Here, receiving the DCI including the reporting trigger indication information in step S51 includes: receiving the DCI sent by a network device, where the DCI includes the reporting trigger indication information.

In this way, in the example of the disclosure, the reporting information is reported to the network device after the reporting trigger indication information of the network device is received by the UE, on the one hand, the reporting information does not need to be reported in real time, thus the signaling overhead may be saved, and on the other hand, unified management of the UE by the network device may also be realized.

Moreover, in the example of the disclosure, since the network device may carry the reporting trigger indication information in the DCI to be sent, two functions may be realized through the sending of the one piece of DCI: an original function of the DCI, and a function of triggering the reporting of the reporting information of the UE, so that the utilization of the DCI can be improved, and the signaling overhead can be reduced.

It needs to be noted that, it may be understood by those skilled in the art that the method provided by the example of the disclosure may be executed individually, or together with some methods in the examples of the disclosure or some methods in the related art.

In an example, the plurality of beams in step S41 may be a plurality of downlink beams.

In an example, at least some of the plurality of downlink beams in step S41 have corresponding uplink beams, and/or at least some of the plurality of downlink beams do not have corresponding uplink beams.

In some examples, the reporting information includes an indication field, where the indication field indicates a reported single downlink beam does not have a corresponding uplink beam.

Here, the indication field may be a predetermined indication field or a reserved indication field in the reporting information. The predetermined indication field or the reserved indication field may be specified by a wireless communication protocol, or the predetermined indication field or the reserved indication field may be determined by consultation between the UE and the network device. The indication field may be one or more bits in the reporting information.

In some examples, the indication field indicates, in a case where being configured by default, a reported single downlink beam does not have a corresponding uplink beam; or, the indication field indicates, in a case where carrying a first value, the reported single downlink beam does not have a corresponding uplink beam.

For example, if no value is carried in the indication field, i.e., the indication field is configured by default, the indication field indicates a reported single downlink beam does not have a corresponding uplink beam.

For example, if the indication field carries a first value, such as “0”, the indication field indicates that the reported single downlink beam does not have a corresponding uplink beam.

In this way, the example of the disclosure may indicate that the reported single downlink beam does not have a corresponding uplink beam by setting a certain indication field in the reporting information.

In other examples, the indication field also carries identification information of the reported single downlink beam, to indicate which downlink beam or which downlink beams do not have corresponding uplink beams.

In other examples, it may be that, when the indication field carries a first value, the indication field indicates that the reported single downlink beam does not have a corresponding uplink beam; or, when the indication field carries a second value, the indication field indicates that the reported single downlink beam has a corresponding uplink beam. Thus, in the example of the disclosure, whether which downlink beam or which downlink beams have corresponding uplink beams may be indicated by the indication field.

It needs to be noted that, it may be understood by those skilled in the art that the method provided by the example of the disclosure may be executed individually, or together with some methods in the examples of the disclosure or some methods in the related art.

In some examples, sending the reporting information in step S41 includes:
sending the reporting information based on a beam reporting mode; where the beam reporting mode is a group-based beam reporting mode configured to the UE, and the reporting information is reported based on the beam reported by each measurement; or, sending the reporting information based on a beam reporting mode; where the beam reporting mode is a non-group based beam reporting mode configured to the UE, and the reporting information is reported based on the beam reported by each measurement.

An example of the disclosure provides a method for beam reporting enhancement, performed by UE, including: sending the reporting information based on a beam reporting mode; where the beam reporting mode is a group-based beam reporting mode configured to the UE, and the reporting information is reported based on the beam reported by each measurement; or, sending the reporting information based on a beam reporting mode; where the beam reporting mode is a non-group based beam reporting mode configured to the UE, and the reporting information is reported based on the beam reported by each measurement.

Here, when the UE is configured to the group-based beam reporting mode, although the reported beams are beam pairs, the identification information of the beam is still determined for each beam when the identification information of the beams is determined, in the reporting information, it is also performed based on the beam reported by each measurement.

In the example of the disclosure, the reporting information may be sent regardless of whether the UE is configured to the group-based beam reporting mode or is configured to the non-group based beam reporting mode. The reporting information may be identification information that includes different UE capability value set indexes, and/or identification information with different antenna panel information indexes when the same UE capability value set indexes are included. Moreover, regardless of whether the UE is configured to the group-based beam reporting mode or is configured to the non-group based beam reporting mode, it adapts to a mode of determining the identification information of the beams of the example of the disclosure.

An example of the disclosure provides a method for beam reporting enhancement, performed by UE, including: sending beam reporting based on a beam reporting mode, where the beam reporting mode a group-based beam reporting mode configured to the UE. Reporting information is reported based on a beam pair of measured beams.

Here, the beam pair may be two or more beams. For example, if UE capability value set indexes of the two beams are the same, reporting of identification information and the like may be performed based on the beam pair of the two beams.

In this way, in the example of the disclosure, if the UE is configured to the group-based reporting mode, reporting may also be performed based on the beam pair of the beam measurement, and thus, the signaling overhead may be further saved.

It needs to be noted that, it may be understood by those skilled in the art that the method provided by the example of the disclosure may be executed individually, or together with some methods in the examples of the disclosure or some methods in the related art.

An example of the disclosure provides a method for beam reporting enhancement, performed by UE, including: determining identification information of beams.

In some examples, the method includes at least one of the following steps: determining, based on antenna panel indexes corresponding to the plurality of beams, identification information corresponding to each beam on the plurality of beams or identification information corresponding to each beam pair; determining the identification information corresponding to each of the plurality of beams based on antenna panel indexes of different antenna panels corresponding to the plurality of beams; determining the identification information corresponding to each of a first type of beams, in a case where the UE capability value set indexes of the first type of beams in the plurality of beams are different, based on the UE capability value set indexes of the first type of beams; and determining the identification information corresponding to each of a second type of beams, in a case where the UE capability value set indexes of the second type of beams in the plurality of beams are different, based on the UE capability value set indexes of the second type of beams as well as different antenna panel information indexes.

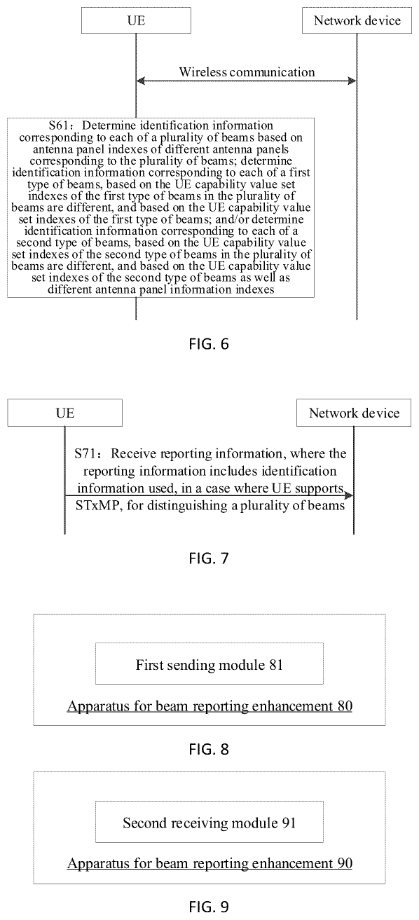

As shown in FIG. 6, an example of the disclosure provides a method for beam reporting enhancement, performed by UE, including step S61.
Step S61: identification information corresponding to each of a plurality of beams is determined based on antenna panel indexes of different antenna panels corresponding to the plurality of beams; and/or identification information corresponding to each of a first type of beams is determined, in a case where the UE capability value set indexes of the first type of beams in the plurality of beams are different, based on the UE capability value set indexes of the first type of beams; and/or identification information corresponding to each of a second type of beams is determined, in a case where the UE capability value set indexes of the second type of beams in the plurality of beams are different, based on the UE capability value set indexes of the second type of beams as well as different antenna panel information indexes.

For example, the identification information of the beams is determined based on the antenna panel indexes of the antenna panels corresponding to the beams. For example, the plurality of beams reported in the reporting information include a beam 1 and a beam 2. The beam 1 and the beam 2 are beams from an antenna panel 1 and an antenna panel 2 respectively. An antenna panel index of the antenna panel 1 is “panel #1”, and an antenna panel index of the antenna panel 2 is “panel #2”; and thus, the identification information of the beam 1 and the beam 2 may be respectively “panel #1” and “panel #2”. Here, representation information of the beams may be determined directly based on the antenna panel indexes of the antenna panels.

For example, if a case of whether the antenna panel indexes corresponding to the plurality of beams are for different antenna panels is not considered, the antenna panel indexes of the antenna panels corresponding to the plurality of beams may also be reported directly. For example, four beams (1, 2, 3, 4) of the reporting information correspond to three panels (1, 3, 3, 5) respectively, and then panel related information indexes reported by each of the four beams may be (1, 3, 3, 5) respectively.

For example, if a case of whether the antenna panel indexes corresponding to the plurality of beams are for different antenna panels is not considered, the antenna panel information indexes of the antenna panels corresponding to the plurality of beams may also be reported directly. For example, four beams (1, 2, 3, 4) of the reporting information correspond to three panels (1, 3, 3, 5) respectively, and if the three panels are numbered as (1, 2, 3) respectively, then panel related information indexes reported by each of the four beams may be (1, 2, 2, 3) respectively.

In some examples of the disclosure, in a case where the antenna panel indexes of the plurality of beams or the plurality of antenna panel information indexes are for the same antenna panel, the identification information of the plurality of beams may also be reported to the base station by the UE. This may allow the base station to determine that the identification information of the plurality of beams is a plurality of beams that do not support STxMP.

For example, four beams (1, 2, 3, 4) of the reporting information correspond to three panels (1, 3, 3, 5) respectively, and then identification information of beam pairs may also be reported for the four beams, e.g., panel related indexes of the two beam pairs (1, 2) and (3, 4) may be reported directly as (1, 3) and (3, 5). Or, if the three panels are numbered as (1, 2, 3) respectively, panel related indexes of the two beam pairs (1, 2) and (3, 4) are reported as (1, 2) and (2, 3). In this way, the determination that beams from different antenna panels in the beam pairs are beam pairs that support STxMP can also be realized to some extent by the reporting of the beam pairs.

For example, the identification information of the beams is determined based on the UE capability value set indexes of the beams. For example, the plurality of beams reported in the reporting information include two beams with different UE capability value set indexes, the UE capability value set indexes of the two beams are “UE capability value set index #3” or “UE capability value set index #4” respectively, and then it is determined that the UE capability value set indexes of the two beams are the identification information of the beams.

For example, the identification information of the beams is determined based on the UE capability value set indexes of the beams and the antenna panel information indexes. For example, the plurality of beams reported in the reporting information include four beams with the same UE capability value set indexes, and the UE capability value set indexes of the four beams are all “UE capability value set index #1”. The four beams are numbered by the UE, it is determined that the antenna panel information indexes of the four beams are “#1”, “#2”, “#3”, and “#4” respectively, and then combinations of the beam UE capability value set indexes of the beams and the antenna panel information indexes are determined as the identification information of the beams. For example, the identification information of the four beams is determined as “capability value set index #1, #1”, “capability value set index #1, #2”, “capability value set index #1, #3”, and “capability value set index #1, #4” respectively.

For example, the antenna panel information indexes may also be determined by UE capability value set indexes of the beams or may also be determined by the antenna panel indexes, and then the identification information of the beams is determined based on the UE capability value set indexes of the beams and the antenna panel indexes. For example, the plurality of beams reported in the reporting information include four beams with the same UE capability value set indexes, and the UE capability value set indexes of the four beams are all “UE capability value set index #1”. The four beams are numbered by the UE, it is determined that the antenna panel information indexes of the four beams are “panel #1”, “panel #2”, “panel #3”, and “panel #4” respectively, and then combinations of the beam UE capability value set indexes of the beams and the antenna panel information indexes are determined as the identification information of the beams. For example, the identification information of the four beams is determined as “capability value set index #1, panel #1”, “capability value set index #1, panel #2”, “capability value set index #1, panel #3”, and “capability value set index #1, panel #4” respectively.

In this way, in the example of the disclosure, identification information of each beam or at least some beams of the plurality of beams may be determined in the mode such that the network device may determine, based on the identification information, whether the plurality of beams are beams from different antenna panels. Moreover, since the identification information of the beams may be determined in various modes, it may adapt to more application scenarios.

It needs to be noted that, it may be understood by those skilled in the art that the method provided by the example of the disclosure may be executed individually, or together with some methods in the examples of the disclosure or some methods in the related art.

In some examples, sending the reporting information in step S41 includes:
sending reporting information of beams of a first number of antenna panels in a case where the UE supports uplink simultaneous transmission of the first number of antenna panels; where the first number is less than or equal to a second number, and the second number is a number of antenna panels that the UE has.

An example of the disclosure provides a method for beam reporting enhancement, performed by UE, including: sending reporting information of beams of a first number of antenna panels in a case where the UE supports uplink simultaneous transmission of the first number of antenna panels; where the first number is less than or equal to a second number, and the second number is a number of antenna panels that the UE has.

For example, the UE has simultaneous transmission of beams of seven antenna panels, while the UE can support simultaneous transmission of beams of up to four antenna panels, and thus the UE determines to report reporting information of the beams on merely the four antenna panels.

In this way, in the example of the disclosure, the UE may report the reporting information of the beams of the antenna panels that actually perform simultaneous transmission according to the actual number of antenna panels supported by the UE, thus, unnecessary reporting information may be reduced, and the signaling overhead may be reduced.

It needs to be noted that, it may be understood by those skilled in the art that the method provided by the example of the disclosure may be executed individually, or together with some methods in the examples of the disclosure or some methods in the related art.

In some examples, sending the reporting information in step S41 includes at least one of the following:
sending the reporting information in a case where the UE supports reporting of P-CSI; sending the reporting information in a case where the UE supports reporting of AP-CSI; and sending the reporting information in a case where the UE supports reporting of SP-CSI.

An example of the disclosure provides a method for beam reporting enhancement, performed by UE, including at least one of the following:
sending the reporting information in a case where the UE supports reporting of P-CSI; sending the reporting information in a case where the UE supports reporting of AP-CSI; and sending the reporting information in a case where the UE supports reporting of SP-CSI.

For example, the reporting of the reporting information is supported when the UE may support the reporting of the P-CSI by default; or the reporting of the reporting information is supported when the UE selectively supports the reporting of the AP-CSI and/or the SP-CSI.

For example, the reporting of the reporting information is supported when the UE may support at least one of reporting of the P-CSI, reporting of the AP-SCI, or reporting of the SP-CSI by default.

In the example of the disclosure, a capability of the UE is defined. For example, if the UE reports that merely reporting of the P-CSI is supported, reporting of the enhanced reporting information above can merely be performed by configuring the periodic CSI (P-CSI) during configuration of the network device.

In the example of the disclosure, a capability is defined in which the UE may support the reporting of enhanced reporting information when the UE may support at least one of reporting of P-CSI, reporting of AP-SCI, or reporting of SP-SCI, such that this support of reporting of enhanced reporting information may adapt to scenarios of at least one of reporting of P-CSI, AP-SCI, or SP-SCI.

It needs to be noted that, it may be understood by those skilled in the art that the method provided by the example of the disclosure may be executed individually, or together with some methods in the examples of the disclosure or some methods in the related art.

In some examples, the reporting information is used for a network device to schedule the UE to perform uplink support on uplink transmission based on a single downlink control information (S-DCI) schedule, or, the reporting information is used for the network device to schedule the UE to perform uplink support on uplink transmission based on a multiple downlink control information (M-DCI) schedule.

In the example of the disclosure, the enhanced reporting information may be available for the network device, such as a base station, to schedule uplink S-DCI-based transmission or uplink M-DCI-based transmission, which may be applicable to more application scenarios.

It needs to be noted that, it may be understood by those skilled in the art that the method provided by the example of the disclosure may be executed individually, or together with some methods in the examples of the disclosure or some methods in the related art.

The following method for beam reporting enhancement, which is performed by a network device, is similar to the above description of the method for beam reporting enhancement performed by the UE; and for technical details not disclosed in the example of the method for beam reporting enhancement performed by the network device, please refer to the description of the examples of the method for beam reporting enhancement performed by the UE, which will not be described in detail here.

As shown in FIG. 7, an example of the disclosure provides a method for beam reporting enhancement, performed by a network device, including step S71.
Step S71: reporting information is received, where the reporting information includes identification information used, in a case where UE supports STxMP, for distinguishing a plurality of beams.

In some examples of the disclosure, the reporting information may be the reporting information in step S41; the identification information of the beams may be the identification information of the beams in step S41; and antenna panel information indexes may be the antenna panel information indexes in step S41.

Here, antenna panel information indexes that are simultaneously reported in step S71 are merely for reported beams with the same UE capability value set indexes obtained from this CSI measurement.

For example, the identification information at least includes corresponding different antenna panel information indexes in a case where UE value set indexes of the plurality of beams are the same.

For example, the identification information includes corresponding different antenna panel information indexes and different UE capability value set indexes of the plurality of beams in a case where UE capability value set indexes of the plurality of beams are the same.

For example, the identification information of each of the plurality of beams is determined based on the antenna panel indexes of the different antenna panels corresponding to the plurality of beams.

For example, identification information of a first type of beams of the plurality of beams is determined based on UE capability value set indexes of the first type of beams. The UE capability value set indexes of the first type of beams are different.

For example, identification information of a second type of beams of the plurality of beams is determined based on UE capability value set indexes of the second type of beams and antenna panel information indexes of the second type of beams. The UE capability value set indexes of the second type of beams are the same, and the antenna panel information indexes of the second type of beams are different.

For example, the reporting information includes an indication field, where the indication field indicates a reported single downlink beam does not have a corresponding beam.

For example, when the indication field is configured by default, the indication field indicates that the reported single downlink beam does not have a corresponding uplink beam; or, when the indication field carries a first value, the indication field indicates that the reported single downlink beam does not have a corresponding uplink beam.

An example of the disclosure provides a method for beam reporting enhancement, performed by a network device, including: sending reporting trigger indication information, where the reporting trigger indication information is used for indicating UE to report reporting information.

Here, the network device sending the reporting trigger indication information may be:
the reporting trigger indication information is sent to the UE by the network device.

An example of the disclosure provides a method for beam reporting enhancement, performed by a network device, including: sending DCI including reporting trigger indication information, where the reporting trigger indication information is used for indicating UE to report reporting information for a beam measurement.

In some examples, receiving the reporting information in step S71 includes:
receiving the reporting information based on a beam reporting mode, where the beam reporting mode is a group-based beam reporting mode configured to the UE, and the reporting information is reported based on the beam reported by each measurement; or, receiving the reporting information based on a beam reporting mode, where the beam reporting mode is a non-group based beam reporting mode configured to the UE, and the reporting information is reported based on the beam reported by each measurement.

An example of the disclosure provides a method for beam reporting enhancement, performed by a network device, including:
receiving the reporting information based on a beam reporting mode, where the beam reporting mode is a group-based beam reporting mode configured to the UE, and the reporting information is reported based on the beam reported by each measurement; or, receiving the reporting information based on a beam reporting mode, where the beam reporting mode is a non-group based beam reporting mode configured to the UE, and the reporting information is reported based on the beam reported by each measurement.

In some examples, receiving the reporting information in step S71 includes:
receiving reporting information of beams of a first number of antenna panels, where the first number is a number of antenna panels of simultaneous transmission via panel supported by the UE; where the first number is less than or equal to a second number, and the second number is a number of antenna panels the UE has.

An example of the disclosure provides a method for beam reporting enhancement, performed by a network device, including:
receiving reporting information of beams of a first number of antenna panels, where the first number is a number of antenna panels of simultaneous transmission via panel supported by the UE; where the first number is less than or equal to a second number, and the second number is a number of antenna panels the UE has.

In some examples, the reporting information is reported by the UE in a case where the UE supports at least one of reporting of P-CSI, reporting of AP-CSI, or reporting of SP-CSI.

An example of the disclosure provides a method for beam reporting enhancement, performed by a network device, including: determining, based on reporting information, to schedule UE to perform uplink support on uplink transmission based on an S-DCI schedule; or, determining, based on the reporting information, to schedule the UE to perform uplink support on uplink transmission based on an M-DCI schedule.

This implementation may refer to the description of the UE side, which will not be repeated here.

It needs to be noted that, it may be understood by those skilled in the art that the method provided by the example of the disclosure may be executed individually, or together with some methods in the examples of the disclosure or some methods in the related art.

To further explain any example of the disclosure, a specific example is provided below.

An example of the disclosure provides a method for beam reporting enhancement, performed by a communication device. The communication device includes UE and a network device; and the method for beam reporting enhancement includes the following steps (not shown).
Step S81A: reporting information of beams is reported by the UE based on a beam reporting mode, the beam reporting mode is a group-based beam reporting mode configured to the UE. The reporting information includes identification information.

The reported identification information includes the following cases.

Case 1, the reported identification information is determined based on antenna panel indexes of different antenna panels corresponding to the plurality of beams. For example, the antenna panel indexes of the antenna panels corresponding to the two reported beams are “panel #1” and “panel #2” respectively, and then the identification information of the two beams may be “panel #1” and “panel #2” respectively.

Case 2: the reported identification information is determined based on same UE capability value set indexes of the plurality of beams and the antenna panel information indexes of the beams. For example, the UE capability value set indexes of the four reported beams are all “UE capability value set index #X”, and the antenna panel information indexes of the four beams are “panel #1”, “panel #2”, “panel #3” and “panel #4” respectively, and then the identification information of the four beams are “UE capability value set index #X, panel #1”, “UE capability value set index #X, panel #2”, “UE capability value set index #X, panel #3”, and “UE capability value set index #X, panel #4”respectively.

Case 3: the reported identification information is determined based on different UE capability value set indexes of the plurality of beams. For example, UE capability value set indexes corresponding to the two reported beams are “UE capability value set index #3” and “UE capability value set index #4” respectively, and then the identification information of the two beams may be “UE capability value set index #3” and “UE capability value set index #4” respectively.

Case 4: the identification information of the plurality of reported beams is identification information of beams corresponding to the number of antenna panels supported by the UE. For example, the UE has a second number of antenna panels, but the UE supports uplink simultaneous transmission of beams of up to a first number of antenna panels, and then the UE reports identification information of beams of a first number of antenna panels, where the first number is less than or equal to the second number.

The reported reporting information further includes the following cases.

Case 5: the reporting information includes the identification information, the reporting information further includes an indication field, and the indication field is used for indicating that a reported single downlink beam does not have a corresponding beam. For example, the indication field indicates, in a case where being configured by default, the reported single downlink beam does not have a corresponding uplink beam. For another example, when carrying a first value, the indication field indicates that the reported single downlink beam does not have a corresponding uplink beam. For example, the first value may be “0”.
Step S81B: reporting information of beams is reported by the UE based on a beam reporting mode, the beam reporting mode is a non-group based beam reporting mode configured to the UE. The reporting information includes identification information. The reported identification information may include at least one of case 1 to case 4 in step S81A above; and/or, the reported reporting information may include case 5 in step S81A.

In an optional example, the UE supports reporting of reporting information in a case where the UE supports at least one of the reporting of P-CSI, the reporting of SP-SCI, or the reporting of AP-SCI.
Step S82: the network device, based on the reporting information, determines to schedule the UE to perform uplink support on uplink transmission based on an S-DCI schedule, or, based on the reporting information, determines to schedule the UE to perform uplink support on uplink transmission based on an M-DCI schedule.

It needs to be noted that, it may be understood by those skilled in the art that the method provided by the example of the disclosure may be executed individually, or together with some methods in the examples of the disclosure or some methods in the related art.

As shown in FIG. 8, an example of the disclosure provides an apparatus for beam reporting enhancement 80, including a first sending module 81.

The first sending module 81 is configured to send reporting information, where the reporting information includes identification information used, in a case where the UE supports STxMP, for distinguishing a plurality of beams.

In some examples, the identification information at least includes corresponding different antenna panel information indexes in a case where UE capability value set indexes of the plurality of beams are the same.

The apparatus for beam reporting enhancement provided by the example of the disclosure may be applied in UE.

In some examples, the identification information further includes different UE capability value set indexes of the plurality of beams.

An example of the disclosure provides an apparatus for beam reporting enhancement, including: a first sending module 81, configured to send reporting information, where the reporting information includes identification information of a plurality of beams in a case where the UE supports STxMP. The identification information at least includes corresponding different antenna panel information indexes in a case where UE capability value set indexes of the plurality of beams are the same, and the identification information further includes different UE capability value set indexes of the plurality of beams.

An example of the disclosure provides an apparatus for beam reporting enhancement 80, including: a first receiving module (not shown), configured to receive DCI including reporting trigger indication information, where the reporting trigger indication information is used for indicating the UE to report the reporting information for a beam measurement.

An example of the disclosure provides an apparatus for beam reporting enhancement 80, including: a first sending module 81, configured to send reporting information based on a beam reporting mode; where the beam reporting mode is a group-based beam reporting mode configured to the UE, and the reporting information is reported based on a beam reported by each measurement.

An example of the disclosure provides an apparatus for beam reporting enhancement 80, including: a first sending module 81, configured to send reporting information based on a beam reporting mode; where the beam reporting mode is a non-group based beam reporting mode configured to the UE, and the reporting information is reported based on a beam reported by each measurement.

An example of the disclosure provides an apparatus for beam reporting enhancement, including: a first processing module (not shown); where the first processing module is configured to execute at least one of the following steps:
determining the identification information corresponding to each of the plurality of beams based on antenna panel indexes of different antenna panels corresponding to the plurality of beams; determining the identification information corresponding to each of a first type of beams, in a case where the UE capability value set indexes of the first type of beams in the plurality of beams are different, based on the UE capability value set indexes of the first type of beams; or determining the identification information corresponding to each of a second type of beams, in a case where the UE capability value set indexes of the second type of beams in the plurality of beams are different, based on the UE capability value set indexes of the second type of beams as well as different antenna panel information indexes.

An example of the disclosure provides an apparatus for beam reporting enhancement 80, including: a first sending module 81, configured to send reporting information of beams of a first number of antenna panels in a case where the UE supports uplink simultaneous transmission of the first number of antenna panels; where the first number is less than or equal to a second number, and the second number is a number of antenna panels the UE has.

In some examples, the reporting information includes an indication field, where the indication field indicates a reported single downlink beam does not have a corresponding uplink beam.

In some examples, the indication field indicates, in a case where being configured by default, a reported single downlink beam does not have a corresponding uplink beam; or, the indication field carries a first value and is used for indicating that the reported single downlink beam does not have a corresponding uplink beam.

An example of the disclosure provides an apparatus for beam reporting enhancement, including: a first sending module, configured to execute at least one of the following steps:
sending the reporting information in a case where the UE supports reporting of P-CSI; sending the reporting information in a case where n the UE supports reporting of AP-CSI; or sending the reporting information in a case where the UE supports reporting of SP-CSI.

In some examples, the reporting information is used for a network device to schedule the UE to perform uplink support on uplink transmission based on a single downlink control information (S-DCI) schedule, or, the reporting information is used for the network device to schedule the UE to perform uplink support on uplink transmission based on a multiple downlink control information (M-DCI) schedule.

As shown in FIG. 9, an example of the disclosure provides an apparatus for beam reporting enhancement 90, including a second receiving module 91.

The second receiving module 91 is configured to receive reporting information, where the reporting information includes identification information used, in a case where UE supports STxMP, for distinguishing a plurality of beams.

In some examples, the identification information at least includes corresponding different antenna panel information indexes in a case where UE capability value set indexes of the plurality of beams are the same.

The apparatus for beam reporting enhancement provided by the example of the disclosure may be applied in a network device.

In some examples, the identification information further includes different UE capability value set indexes of the plurality of beams.

An example of the disclosure provides an apparatus for beam reporting enhancement, including: a second sending module (not shown), configured to send DCI including reporting trigger indication information, where the reporting trigger indication information is used for indicating the UE to report the reporting information for a beam measurement.

An example of the disclosure provides an apparatus for beam reporting enhancement 90, including: a second receiving module 91, configured to receive reporting information based on a beam reporting mode; where the beam reporting mode is a group-based beam reporting mode configured to the UE, and the reporting information is reported based on a beam reported by each measurement.

An example of the disclosure provides an apparatus for beam reporting enhancement 90, including: a second receiving module 91, configured to receive reporting information based on a beam reporting mode; where the beam reporting mode is a non-group based beam reporting mode configured to the UE, and the reporting information is reported based on a beam reported by each measurement.

An example of the disclosure provides an apparatus for beam reporting enhancement 90, including: a second receiving module 91, configured to receive reporting information of beams of a first number of antenna panels, where the first number is a number of antenna panels of simultaneous transmission via panel supported by the UE; where the first number is less than or equal to a second number, and the second number is a number of antenna panels the UE has.

In some examples, the reporting information includes an indication field, where the indication field indicates a reported single downlink beam does not have a corresponding beam.

In some examples, the indication field indicates, in a case where being configured by default, a reported single downlink beam does not have a corresponding uplink beam; or, the indication field carries a first value and is used for indicating that the reported single downlink beam does not have a corresponding uplink beam.

In some examples, the reporting information is reported by the UE in a case where the UE supports at least one of reporting of P-CSI, reporting of AP-CSI, or reporting of SP-CSI.

An example of the disclosure provides an apparatus for beam reporting enhancement, including: a second processing module (not shown), configured to determine, based on the reporting information, to schedule the UE to perform uplink support on uplink transmission based on an S-DCI schedule.

An example of the disclosure provides an apparatus for beam reporting enhancement, including: a second processing module, configured to determine, based on the reporting information, to schedule UE to perform uplink support on uplink transmission based on an M-DCI schedule.

It needs to be noted that, it may be understood by those skilled in the art that the apparatus provided by the example of the disclosure may be executed individually, or together with some apparatuses in the examples of the disclosure or some apparatuses in the related art.

As for the apparatus in the included examples, a specific mode in which each module executes operations has been described in detail in the examples of the method, which will not be described in detail here.

An example of the disclosure provides a communication device, including:
a processor; and a memory configured to store executable instructions for the processor. Where the processor is configured to: perform a method for beam reporting enhancement of any example of the disclosure when executing the executable instructions.

In an example, the communication device may include, but is not limited to, at least one of: a network device or UE.

The processor may include various types of storage media. The storage media are non-temporary computer storage media, and can continue to memorize information stored after the user equipment is powered down.

The processor may be connected with the memory via a bus and the like, and is configured to read the executable program stored on the memory, such as at least one of the methods shown in FIG. 4 to FIG. 7.

An example of the disclosure further provides a non-transitory computer storage medium, storing a computer executable program, and the executable program implements the method for beam reporting enhancement of any example of the disclosure when executed by a processor, for example, at least one of the methods as shown in FIG. 4 to FIG. 7.

As for the apparatuses or storage media in the examples, a specific mode in which each module performs operations has been described in detail in the examples of the method, which will not be described in detail here.

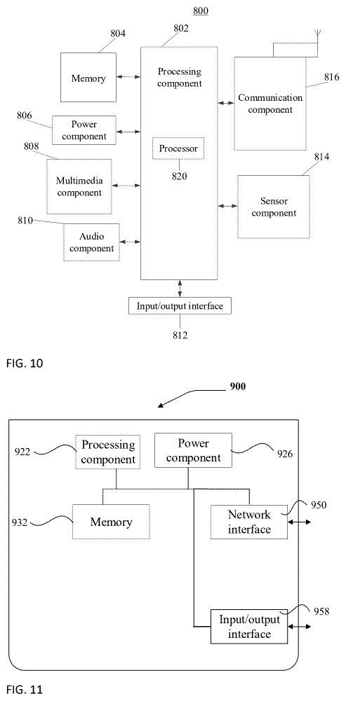

FIG. 10 is a block diagram of user equipment 800 illustrated according to an example. For example, the user equipment 800 may be a mobile phone, a computer, digital broadcasting user equipment, a messaging device, a game console, a tablet device, a medical device, a fitness device, a personal digital assistant, etc.

Referring to FIG. 10, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls an overall operation of the user equipment 800, such as operations associated with display, a telephone call, a data communication, a camera operation, and a recording operation. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the user equipment 800. Examples of these data include instructions for any application or method operating on the user equipment 800, contact data, phonebook data, messages, pictures, videos, etc. The memory 804 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 806 provides power for various components of the user equipment 800. The power component 806 may include a power management system, one or more power sources and other components associated with generating, managing and distributing power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor can not only sense the boundary of the touch or sliding operation, but also detect the duration and pressure related to the touch or sliding operation. In some examples, the multimedia component 808 includes a front camera and/or a rear camera. When the user equipment 800 is in an operation mode, such as a shooting mode or a video mode, the front camera and/or the rear camera can receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the user equipment 800 is in the operation mode, such as a call mode, a recording mode, and a speech recognition mode. The received audio signal may be further stored in the memory 804 or transmitted via the communication component 816. In some examples, the audio component 810 also includes a speaker for outputting an audio signal.

The I/O interface 812 provides an interface between the processing component 802 and a peripheral interface module which may be a keyboard, a click wheel, a button, etc. These buttons may include but are not limited to: a home button, a volume button, a start button and a lock button.

The sensor component 814 includes one or more sensors for providing state evaluation of various aspects of the user equipment 800. For example, the sensor component 814 may detect an open/closed state of the equipment 800, the relative positioning of components, such as the components being a display and a keypad of the user equipment 800, and the sensor component 814 may also detect a change in the position of the user equipment 800 or of a component of the user equipment 800, the presence or absence of user contact with the user equipment 800, an orientation or acceleration/deceleration of the user equipment 800, and a change in temperature of the user equipment 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as Wi-Fi, 4G or 5G, or their combination. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the user equipment 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above methods.

In an example, a non-transitory computer-readable storage medium including instructions, such as the memory 804 including instructions, which can be executed by the processor 820 of the user equipment 800 to complete the above method, is further provided. For example, the non-transitory computer-readable storage medium may be an ROM, a random access memory (RAM), a CD-ROM, a magnetic tape, a floppy disk, an optical data storage device, etc.

As shown in FIG. 11, an example of the disclosure shows a structure of a base station. For example, the base station 900 may be provided as a network side device. Referring to FIG. 11, the base station 900 includes a processing component 922, which further includes one or more processors, and a memory resource represented by a memory 932 for storing instructions, such as applications, that can be executed by the processing component 922. The applications stored in the memory 932 may include one or more modules each corresponding to a set of instructions. In addition, the processing component 922 is configured to execute instructions to execute any method applied to the base station.

The base station 900 may further include a power component 926 configured to perform power management of the base station 900, a wired or wireless network interface 950 configured to connect the base station 900 to the network, and an input/output (I/O) interface 958. The base station 900 can operate an operating system based on the memory 932, such as Windows Server™, Mac OS X™, Unix™, Linux™, FreeBSD™, or the like.

Technical solutions provided by the examples of the disclosure may include the following beneficial effects.

In the examples of the disclosure, the reporting information is sent to the network device by the UE, where the reporting information includes the identification information used, in a case where the UE supports the STxMP, for distinguishing the plurality of beams. Thus, the network device may be enabled to accurately know whether the plurality of reported beams are from different antenna panels, and thus also accurately know whether the uplink beams corresponding to the plurality of beams are uplink beams that support the STxMP; and then, supporting of the STxMP may be facilitated.

Other examples of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the technical field not disclosed here. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes may be made without departing from the scope of the disclosure. The scope of the disclosure is merely limited by the appended claims.

1. A method for beam reporting enhancement, performed by user equipment (UE), comprising:
sending reporting information, wherein the reporting information comprises identification information used, in a case where the UE supports simultaneous transmission via multi-panel (STxMP), for distinguishing a plurality of beams.

2. The method according to claim 1, wherein the identification information comprises at least one of the following:
corresponding different antenna panel information indexes in a case where UE capability value set indexes of the plurality of beams are the same; or
different UE capability value set indexes of the plurality of beams.

3. (canceled)

4. The method according to claim 1, wherein the method comprises:
receiving downlink control information (DCI) comprising reporting trigger indication information, wherein the reporting trigger indication information is used for indicating the UE to report the reporting information for a beam measurement.

5. The method according to claim 1, wherein sending the reporting information comprises:
sending the reporting information based on a beam reporting mode; wherein the beam reporting mode is a group-based beam reporting mode configured to the UE, and the reporting information is reported based on the beam reported by at least one measurement; or
sending the reporting information based on a beam reporting mode; wherein the beam reporting mode is a non-group based beam reporting mode configured to the UE, and the reporting information is reported based on the beam reported by at least one measurement.

6. The method according to claim 1, comprising at least one of the following steps:
determining the identification information corresponding to at least one of the plurality of beams based on antenna panel indexes of different antenna panels corresponding to the plurality of beams;
determining the identification information corresponding to at least one of a first type of beams, in a case where the UE capability value set indexes of the first type of beams in the plurality of beams are different, based on the UE capability value set indexes of the first type of beams; or
determining the identification information corresponding to at least one of a second type of beams, in a case where the UE capability value set indexes of the second type of beams in the plurality of beams are the same, based on the UE capability value set indexes of the second type of beams as well as different antenna panel information indexes.

7. The method according to claim 1, wherein sending the reporting information comprises:
sending reporting information of beams of a first number of antenna panels in a case where the UE supports uplink simultaneous transmission of the first number of antenna panels; wherein the first number is less than or equal to a second number, and the second number is a number of antenna panels the UE has.

8. The method according to claim 1, wherein
the reporting information comprises an indication field, and
the indication field indicates a reported single downlink beam does not have a corresponding uplink beam.

9. The method according to claim 8, wherein
an indication field indicates, in a case where being configured by default, a reported single downlink beam does not have a corresponding uplink beam; or
the indication field indicates, in a case where carrying a first value, the reported single downlink beam does not have a corresponding uplink beam.

10. The method according to claim 1, wherein sending the reporting information comprises at least one of the following steps:
sending the reporting information in a case where the UE supports reporting of periodic channel state information (P-CSI);
sending the reporting information in a case where the UE supports reporting of aperiodic channel state information (AP-CSI); or
sending the reporting information in a case where the UE supports reporting of semi-periodic channel state information (SP-CSI).

11. The method according to claim 1, wherein
the reporting information is used for a network device to schedule the UE to perform uplink support on uplink transmission based on a single downlink control information (S-DCI) schedule, or
the reporting information is used for the network device to schedule the UE to perform uplink support on uplink transmission based on a multiple downlink control information (M-DCI) schedule.

12. A method for beam reporting enhancement, performed by a network device, comprising:
receiving reporting information, wherein the reporting information comprises identification information used, in a case where user equipment (UE) supports simultaneous transmission via multi-panel (STxMP), for distinguishing a plurality of beams.

13. The method according to claim 12, wherein the identification information comprises at least one of the following:
corresponding different antenna panel information indexes in a case where UE capability value set indexes of the plurality of beams are the same; or
different UE capability value set indexes of the plurality of beams.

14. (canceled)

15. The method according to claim 12, wherein the method comprises:
sending downlink control information (DCI) comprising reporting trigger indication information, wherein the reporting trigger indication information is used for indicating the UE to report the reporting information for a beam measurement.

16. The method according to claim 12, wherein receiving the reporting information comprises:
receiving the reporting information based on a beam reporting mode; wherein the beam reporting mode is a group-based beam reporting mode configured to the UE, and the reporting information is reported based on the beam reported by at least one measurement; or
receiving the reporting information based on a beam reporting mode; wherein the beam reporting mode is a non-group based beam reporting mode configured to the UE, and the reporting information is reported based on the beam reported by at least one measurement.

17. The method according to claim 12, wherein receiving the reporting information comprises:
receiving reporting information of beams of a first number of antenna panels, wherein
the first number is a number of antenna panels of simultaneous transmission via panel supported by the UE,
the first number is less than or equal to a second number, and
the second number is a number of antenna panels the UE has.

18. The method according to claim 12, wherein the reporting information comprises an indication field, and the indication field indicates a reported single downlink beam does not have a corresponding beam; wherein
the indication field indicates, in a case where being configured by default, the reported single downlink beam does not have a corresponding uplink beam; or the indication field indicates, in a case where carrying a first value, the reported single downlink beam does not have a corresponding uplink beam.

19. (canceled)

20. The method according to claim 12, wherein the reporting information is reported by the UE in a case where the UE supports at least one of
reporting of periodic channel state information (P-CSI),
reporting of aperiodic channel state information (AP-CSI), or
reporting of semi-periodic channel state information (SP-CSI).

21. The method according to claim 12, wherein the method comprises:
determining, based on the reporting information, to schedule the UE to perform uplink support on uplink transmission based on a single downlink control information (S-DCI) schedule; or
determining, based on the reporting information, to schedule the UE to perform uplink support on uplink transmission based on a multiple downlink control information (M-DCI) schedule.

22.-23. (canceled)

24. A communication device, comprising:
one or more processors; and
a memory configured to store executable instructions for the one or more processors;
wherein the one or more processors are configured to perform the following steps when executing the executable instructions:
sending reporting information, wherein the reporting information comprises identification information used, in a case where the UE supports simultaneous transmission via multi-panel (STxMP), for distinguishing a plurality of beams.

25. A non-transitory computer storage medium, storing a computer executable program, wherein the executable program, when executed by one or more processors, implements the method for beam reporting enhancement according to claim 1.
